(19) United States
(12) Patent Application Publication
(10) Pub. No.: US 2006/0283186 A1
(43) Pub. Date: Dec. 21, 2006

(54) STIRLING CYCLE MACHINES

(76) Inventor: Robert Francis McConaghy, Kirkland, WA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/425,356

(22) Filed: Jun. 20, 2006

Related U.S. Application Data
(60) Provisional application No. 60/692,516, filed on Jun. 21, 2005.

(51) Int. Cl. F02G 1/04; F01B 29/10

(52) U.S. Cl. 60/520

(57) ABSTRACT

A drive mechanism for a Stirling engine includes a piston rod, a displacer rod, a first crankshaft and a second crankshaft. The piston rod has a first end and a second end. The first end of the piston rod is configured to be coupled to a power piston of the Stirling engine. The displacer rod has a first end and a second end, the first end being configured to be coupled to a displacer piston of the Stirling engine. A rhombic drive mechanism comprises a plurality of pivotally connected connection members. The rhombic drive mechanism is configured to convert the linear movement of the piston rod to rotational movement of the first and second crankshaft and to convert linear movement of the piston rod to movement of the displacer rod. A guide is configured to substantially prevent lateral motion while allowing axial movement of at least one of the displacer rod and the piston rod.

### PRIORITY INFORMATION

This application claims the priority benefit under 35 U.S.C. § 119(e) of Provisional Application 60/692,516 filed Jun. 21, 2005, the entirety of which is hereby incorporated by reference herein.

### BACKGROUND OF THE INVENTION

1. Field of the Invention

The present invention relates to engines and, more specifically, to Stirling cycle engines.

2. Description of the Related Art

Stirling cycle engines have a high theoretical thermodynamic efficiency. However, Stirling cycle engines are not as widely used as internal combustion engines because Stirling cycle engines are typically associated with higher cost and lower proven reliability as compared to internal combustion engines.

For example, one type of Stirling cycle engine includes an enclosed chamber, a displacer piston, a power piston and a crankshaft. The displacer piston is positioned within the enclosed chamber and is connected to the crankshaft by a displacer rod, which extends through the walls of the chamber. The power piston is also connected to the crankshaft through a piston rod and has one end that is in communication with the interior of the chamber. With respect to the crankshaft, the displacer piston and the power piston are typically 90 degrees out of phase with each other.

In operation, the displacer piston moves working fluid from a cold side of the chamber to a hot side of the chamber. This causes the working fluid to expand. This expansion pushes the power piston and the piston rod, thereby rotating the crankshaft. As the crankshaft rotates, the displacer piston moves the working fluid to the cold side of the chamber. This causes the working fluid to contract, pulling the piston down. As the piston moves back down, the crankshaft rotates and the displacer piston moves the working fluid to the hot side of the chamber, thereby completing the cycle.

A rhombic drive is a solution to the problem of providing dynamic balance in a single-cylinder-type Stirling cycle engine. In such an engine, the power piston and the displacer piston are positioned within a common cylinder. The displacer rod passes through the piston. The piston rod terminates at a rigid yoke. In a similar manner, the displacer rod also terminates at a rigid yoke. A combination of connecting rods and crank pins are used to couple the yokes to a pair of crankshafts. Timing gears are attached to the crankshaft to insure the symmetrical geometry of the connecting rods and crank pins. In operation, the two crankshafts are counter rotating. The direction of rotation is such that the variation of the volume in the hot space (above the displacer) leads the variation in the volume in the cold space (between the two pistons) by about 120 degrees. This arrangement has made possible the design of single-cylinder-type Stirling engines of high power (e.g., 40 horsepower or more). Although various other aspects of Stirling cycle engines have been improved over the years, the fundamental design of the rhombic drive mechanism has remained the same.

While elegant in many respects, the conventional geared rhombic drive has certain disadvantages. For example, it is relatively large, heavy, and complicated because it utilizes two geared drive shafts, four connecting rods, and it requires that the displacer rod pass through the body of the power piston. A need therefore exists for an improved design of a rhombic drive that minimizes or eliminates at least some of the disadvantages described above.

### SUMMARY OF THE INVENTION

Accordingly, a first embodiment of the present invention comprises a drive mechanism for a Stirling engine. The mechanism includes a piston rod, a displacer rod, a first crankshaft and a second crankshaft. The piston rod has a first end and a second end. The first end of the piston rod is configured to be coupled to a power piston of the Stirling engine. The displacer rod has a first end and a second end, the first end being configured to be coupled to a displacer piston of the Stirling engine. A rhombic drive mechanism comprises a plurality of pivotally connected connection members. The rhombic drive mechanism is configured to convert the linear movement of the piston rod to rotational movement of the first and second crankshaft and to convert linear movement of the piston rod to movement of the displacer rod. A linear constraint is configured to substantially prevent lateral motion while allowing axial movement of at least one of the displacer rod and the piston rod.

Another embodiment of the present invention comprises a Stirling cycle engine that includes a cylinder, a displacer piston, a power piston, a piston rod, a displacer rod, a first crankshaft and a second crankshaft. The displacer piston is configured for reciprocal movement along a first axis within the cylinder. The power piston is configured for reciprocal movement along the first axis in the cylinder. The piston rod has a first end and a second end. The first end is coupled to the power piston. The displacer rod also has a first end and a second end. The first end is coupled to the displacer piston. The displacer rod extends through the power piston and the piston rod. The first crankshaft has a rotational axis that is substantially perpendicular to the first axis. The second crankshaft has a rotational axis that is substantially perpendicular to the first axis and substantially parallel to the rotational axis of the first crankshaft. A first yoke is coupled to the second end of the piston rod. A second yoke is coupled to the second end of the displacer rod. A first pair of connection members are each pivotally coupled to a crank pin for the first crankshaft and one of the first or second yokes. A second pair of connection members are each pivotally coupled a crank pin for the second crankshaft and one of the first or second yokes. A linear constraint is positioned about at least one of the displacer rod or the piston rod.

Another embodiment of the present invention comprises a Stirling cycle engine that includes a cylinder, a displacer piston, and a power piston. The displacer piston is configured for reciprocal movement along a first axis within the cylinder. The power piston is configured for reciprocal movement along the first axis in the cylinder. A piston rod has a first end and a second end with the first end coupled to the power piston. A displacer rod extends at least partially through the power piston and the piston rod. The displacer rod has a first end and a second end. The first end is coupled to the displacer piston. A first crankshaft has a rotational axis that is substantially perpendicular to the first axis. A second crankshaft has a rotational axis that is substantially perpendicular to the first axis and substantially parallel to the rotational axis of the first crankshaft. A rhombic drive mechanism comprises a plurality of pivotally connected connection members. The rhombic drive mechanism is configured to convert the linear movement of the piston rod to the rotational movement of the first and second crankshaft and to convert linear movement of the piston rod to movement of the displacer rod. The engine includes means for constraining, without timing gears, straight-line motion of the displacer rod and the piston rod.

### BRIEF DESCRIPTION OF THE DRAWINGS

FIG. 1 is a schematic illustration of a Stirling cycle engine (or refrigerator) with a conventional rhombic drive.

FIG. 2A is a schematic illustration of a Stirling cycle engine with a rhombic drive having certain features and advantages according to the present invention.

FIG. 2B is a schematic illustration of the forces in the rhombic drive of FIG. 2A when substantially equal torques are applied on the crankshafts.

FIG. 2C is a schematic illustration of the forces in the rhombic drive of FIG. 2A when unequal torques are applied on the crankshafts.

FIG. 3 is a schematic illustration of an embodiment for electrically arranging motor-generators coupled to the rhombic drive of FIG. 2A.

FIG. 4 is a schematic illustration of another embodiment for electrically arranging motor-generators coupled to the rhombic drive of FIG. 2A.

### DETAILED DESCRIPTION OF PREFERRED EMBODIMENTS

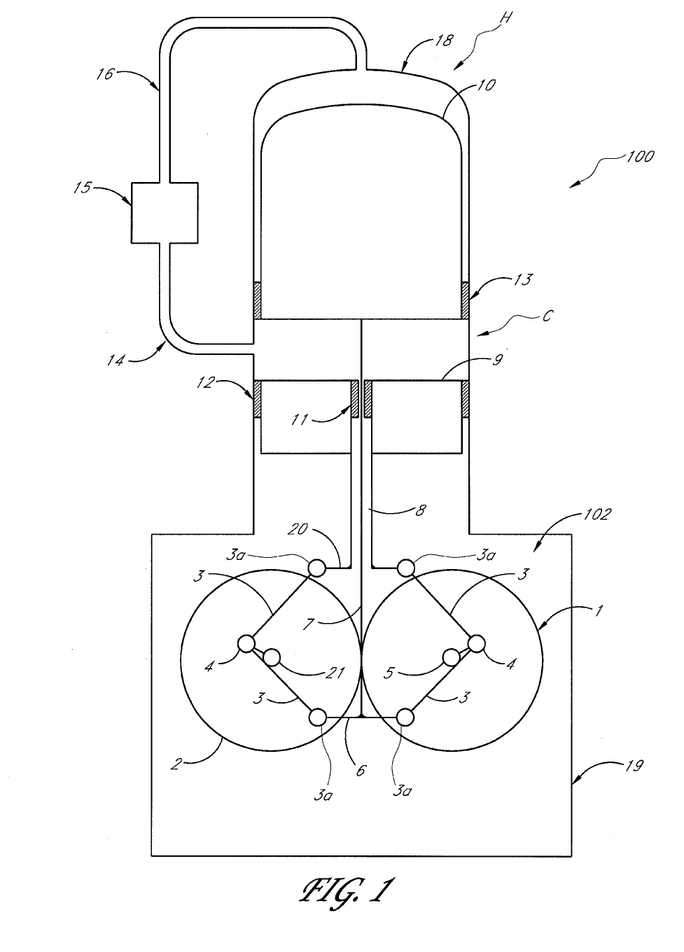

FIG. 1 is a schematic illustration of a Stirling engine 100 with a conventional rhombic drive 102. As shown, the engine 100 includes a power piston 9 and a displacer piston 10 that reciprocate in a cylinder 18. Each piston 9, 10 has a dynamic seal or piston ring 12, 13 respectively to limit gas leakage past either piston 9, 10. In addition, the power piston 9 has another seal 11 to seal a passage through the piston 9 through which the displacer rod 7 passes. The piston rod 8 is coupled to a rigid yoke 20 and the displacer rod 7 is coupled to a similar, second, rigid yoke 6.

As shown in FIG. 1, four connecting rods 3 are rotatably connected through pivot connections or joints 3a to the yokes 20, 6 and a pair of crankpins 4. The combination of the connecting rods 3 and crankpins 4 couple the yokes 20, 6 to a pair of crankshafts 5, 21. Together, the combination of connecting rods 3, crankpins 4, yokes 20, 6 and crankshafts 5, 21 form the rhombic drive mechanism 102 that is enclosed in a crankcase 19.

With continued reference to FIG. 1, a heater 16, a regenerator 15, and a cooler 14 are connected to the cylinder 18 as shown. Timing gears 1 and 2 are coupled to crankshafts 5, 21 and are rotationally coupled to each other to insure that the symmetrical geometry of the drive 102 is maintained, and that the straight line motion of the pistons 9, 10, their rigidly connected rods 8, 7 and their yokes 20, 6 is completely proscribed.

In general, the regenerator 15 can comprise a volume of space through which the working gas passes on its way from the heater 15 to the cooler 14. The regenerator 15 can be configured to absorb heat and, in one embodiment, can be filled with, for example, a porous medium, packed random wire, stacked, fine mesh screens, layers of stainless steel foil (e.g., 0.001″ thick) with narrow gas passages in between or other configurations configured to remove and/or transfer heat to a gas flow. Hot gas traveling from the heater 16 to the cooler 14 pass through the regenerator 15 where a large portion of the heat carried by the gas can be absorbed by the regenerator 15. The gas can thus leave the regenerator 15 several degrees cooler than when it entered the regenerator 15. The remaining heat can then extracted at the cooler 14. In the other direction, the gas picks up the heat energy it previously deposited in the regenerator 15 as it flows from the cooler 14 to the heater 16. Thus, the regenerator 15 can greatly increase the efficiency of the engine 100

In operation, the displacer piston 10 moves working fluid from the cold side C of the cylinder 18 to the hot side H of the cylinder 18. This causes the working fluid to expand. This expansion pushes the power piston 9 and the piston rod 8, thereby rotating the crankshafts 5, 21 through the drive 102. As the crankshafts 5, 21 rotate, the displacer rod 7 is moved through the rhombic drive mechanism 102 causing the displacer piston 10 to move the gaseous working fluid to the cold side C of the cylinder 18. This causes the working fluid to contract, pulling the power piston 9 up. As the power piston 9 moves back up, the crankshafts 6, 21 rotate and the displacer piston 10 moves the working fluid to the hot side H of the cylinder, thereby completing the cycle. The sum of the forces acting on the power piston 9 over one full cycle produces a net work output on the crankshafts 5, 21.

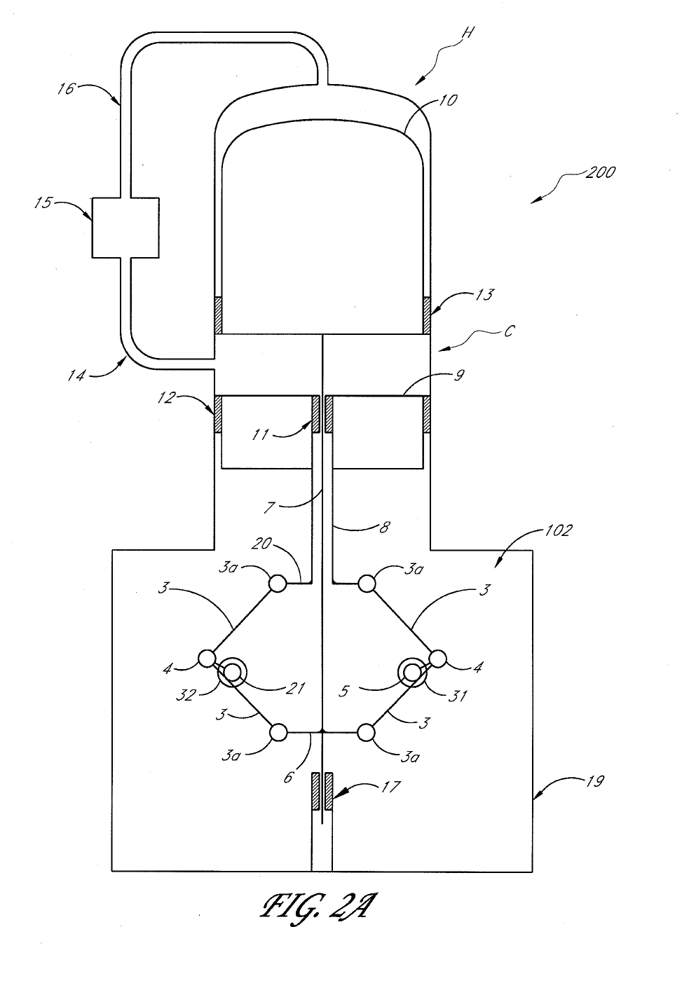

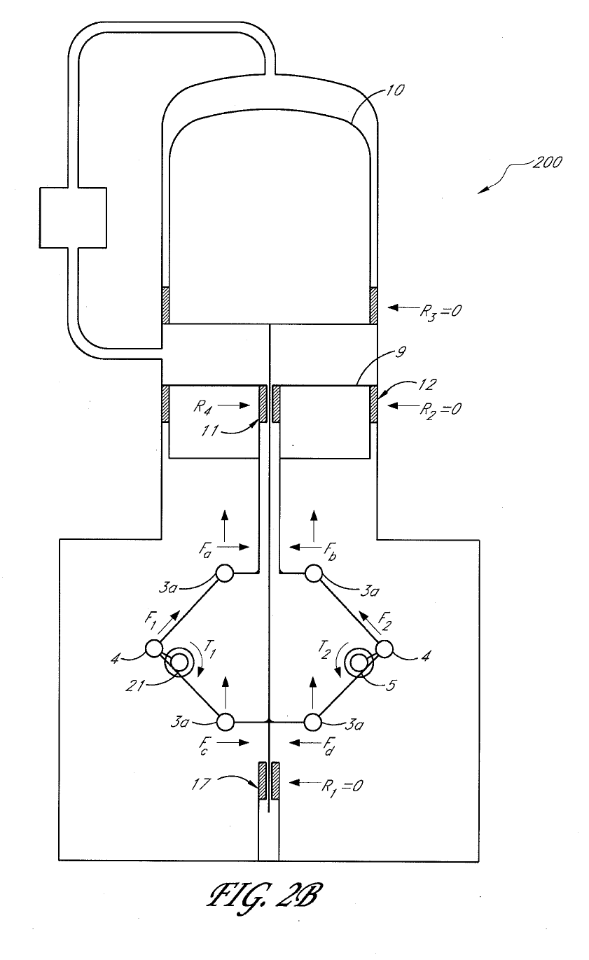

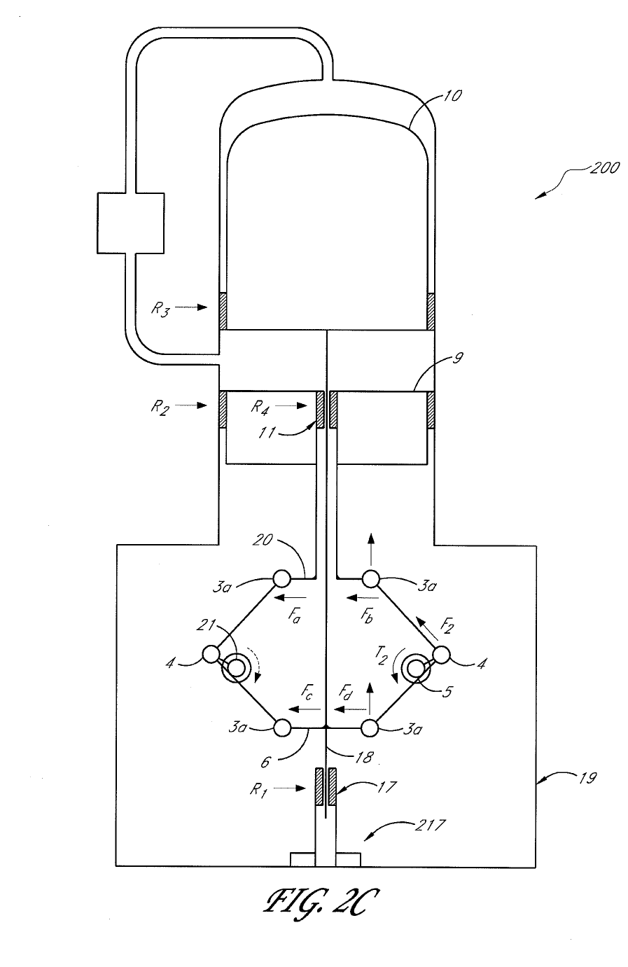

FIG. 2A illustrates an embodiment of a Stirling engine 200 having certain features and advantages according to the present invention. As will be explained below, in this embodiment, the timing gears 1, 2 can be eliminated and replaced with a device, such as a guide 17 to constrain the motion of one or more of the rods operatively coupled to the power piston 9 and a displacer piston 10. In addition to the linear guide or constraint 17, the rhombic drive in this embodiment also includes a piston rod 8 fixedly coupled to the power piston 9, a displacer rod 7 fixedly coupled to displacer piston 10, a plurality of linkages, namely four connecting rods 3 that are rotatably connected to the yokes 20, 6 (or other pivotal connection) and a pair of crankpins 4 consistent with the engine 100 of FIG. 2A described above. The combination of connecting rods 3 and crankpins 4 are used to couple the piston rod 8 and displacer rod 7 with yokes 20, 6 to a pair of crankshafts 5, 21, thereby allowing the oscillatory motion of the power piston 9 to exert a torque on the crankshafts 5, 21 as well as a variable linear force on the displacement piston 10. In accordance with the preferred embodiment, the rhombic drive further includes a guide, preferably a linear guide 17 or linear constraint that constrains the movement of the displacer rod 7 and allows the engine 200 to operate without timing gears while still retaining the desired synchronized movement between the displacer piston 10 and power piston 9 within the cylinder 18. The linear guide 17 may take the form of a bushing or bearing or flexure, for example, installed about displacer rod 7 at a point between the lower end of the piston rod 8 and the lower end of the displacer rod 7 or below the yoke 6 as shown in FIG. 2A. Together, the combination of piston rod 8, displacer rod 7, connecting rods 3, crankpins 4, yokes 20, 6 and crankshafts 5, 21 forms an improved rhombic drive mechanism 202 that is, in the illustrated embodiment, enclosed in the crankcase 19.

As mentioned above, in prior art rhombic drives, the timing gears are part of the kinematic constraints that insure that the motion of each piston and its' rigidly attached piston rod is perfectly linear. However, the timing gears are bulky and heavy. In addition, the gears are a source of noise and potential wear. The gears also require lubrication. Furthermore, the gears require a certain level of clearance, which can result in backlash and/or rocking of the pistons 9, 10 and the mechanism 102, which can cause binding of the pistons and piston rods.

With the timing gears optionally removed to provide a gearless rhombic drive, the linear guide 17 is used to ensure that both pistons 9, 10 are constrained to a substantially straight-line motion. As mentioned above, the guide 17 can be in the form of a bushing or bearing or flexure that is installed near the lower end of the displacer rod 7. In a modified embodiment, the constraint can comprise a “skirt” on either, or both, pistons 9, 10 that is sufficiently long that the cocking force introduced by unequal loading of the output crankshafts is tolerable. In the illustrated embodiment of FIG. 2A, the longest piston rod 7 in the rhombic drive 202 is the one connected to the displacer 10. By placing a linear constraint 17 on the end of this rod 7 opposite the displacer piston 10, the cocking force is reduced, due to the large distance between this constraint and the wear ring 13 on the displacer piston 10. In some embodiments, the linear guide may be operatively coupled to the piston rod 8 to restrict the movement of the piston rod, and the displacer rod 7, to a linear displacement co-parallel to a longitudinal axis of the cylinder in which the pistons 9, 10 oscillate. The guide 17 can be a bearing, a plain bushing, a linear ball bushing, two rollers with machined grooves to accept the rod diameter, or any of a variety of mechanisms that allow axial motion of the rod 7 with minimal constraint while substantially preventing lateral motion.

In this embodiment, it is possible to take power from the engine 200 via one of the crankshafts 5, 21 and guide 17. However, as will be explained with reference to FIGS. 2C, this results in a side load being imposed on both the displacer rod bearing 11 and one or both pistons 9, 10. It is instead preferable to absorb power substantially equally from both crankshafts 5, 21 as shown in FIG. 2B. In FIG. 2B, with power absorbed equally from both crankshafts 5, 21, the torque loads T1, T2 on both shafts 5, 21 is substantially equal and opposite to each other (T1=−T2). This results in the forces (Fa, Fb, Fc, Fd) at the joints 3a being balanced or substantially balanced (e.g., Fa=Fb, Fc=Fd) resulting in side loads (R1, R2, R3, R4) on the guide 17, pistons 9, 10 and rod bearings 11 that are substantially zero or substantially minimal.

As mentioned above, FIG. 2C illustrates a situation where unequal torque loads are applied to the shafts 5, 21. Specifically, a torque T2 is applied only to the second shaft 5 while the first shaft 21 is allowed to freely rotate. The application torque T2 to the second shaft 5 will cause the first shaft 21 to rotate in the direction indicated. However, the forces (Fb, Fd) on the joints 3a near the second shaft 5 act substantially unopposed (e.g,. Fa=0, Fc=0) allowing forces (Fb, Fd) to flow through the mechanism 202 causing reaction forces R1, R2, R3 and R4 to arise. It is highly desirable to reduce or eliminate this side loading R1, R2, R3, R4.

In the embodiment of FIG. 2B, the shafts are loaded in such a way that an equal or substantially equal torque is absorbed from each crankshaft 5, 21. As shown, this results in the reaction forces R1, R2, and R3 being substantially equal to zero. Thus, the engine 200 is preferably configured to extract useful power equally from both crankshafts 5, 21. In one embodiment, equal or substantially equal torque is absorbed through each crankshaft by coupling the crankshafts individually to generators. In another embodiment, the equal or substantially equal torque is absorbed through each crankshaft by coupling the crankshafts individually to two loads, such as two substantially identical or similar generators. As will be explained below, in an example embodiment, the generators are brushless AC generators with permanent magnet rotors and three phase wound stators. In one example, for starting, the generators are operated as motors that are driven in parallel using a suitable brushless motor driver. In the generator mode, the generators function as three phase generators. To avoid interactions between the generators, the output of each generator is rectified and they are connected in series to each other and the external load.

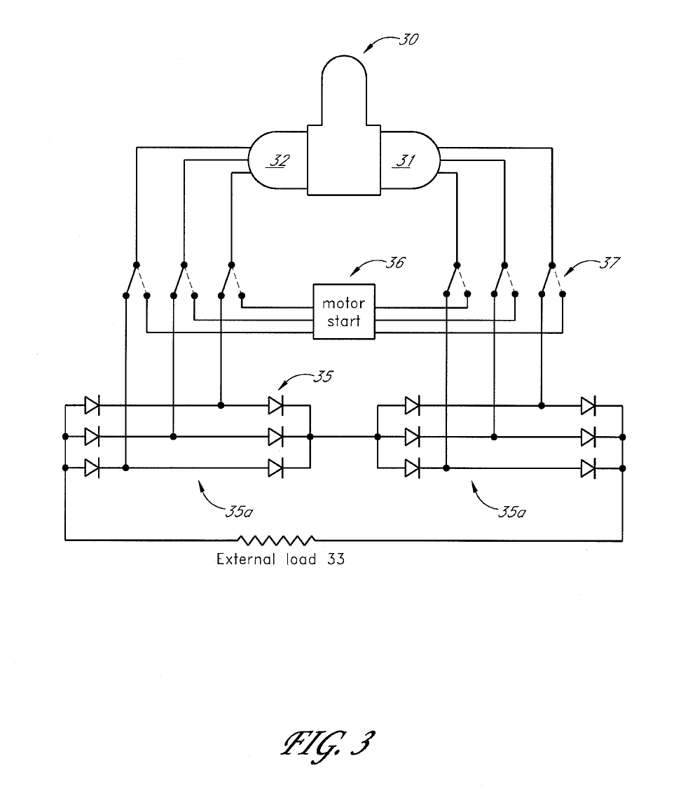

FIG. 3 illustrates one example embodiment of electrically arranging the generators 31, 32, although other arrangements and circuits can be used as well. In this embodiment, the generators 31, 32 can be operated as motors and electrically driven in parallel to start the engine. In an example embodiment, sensors, such as Hall sensors (not shown) can be used to effect brushless commutation. When the engine starts, a bank of six relay contacts 37 are thrown into the “run” position. The generators 31, 32 now function as three phase generators. The three-phase voltage signal of each generator is rectified by a bridge circuit, in this example, a six-diode 35 bridge circuit 35a. The essentially DC output (e.g., a DC output with relatively minor ripple) of the bridge circuits 35a are connected in series to each other and the external load 33. In a modified embodiment, the power is optionally inverted to provide an alternating current (AC) voltage, or otherwise conditioned to suit the load.

The series connection of the generators 31, 32 can provide certain advantages. If instead the generators 31, 32 are connected in parallel, so that they can “see” each other electrically, small differences in phasing between the generators 31, 32 can result in power being transferred back and forth between them, depending on the instantaneous voltage being generated by each. Nonetheless, optionally, the generators can be connected in parallel, preferably with the magnitude and phase of the generator outputs exactly or substantially matched. The generators 31, 32 are mechanically linked to each other by the rhombic drive 202, which has a certain compliance. This can be modeled as a spring-mass system, which has a resonant frequency. In addition to the high electrical losses suffered with a parallel connection (unless the magnitude and phase of the generator outputs are exactly or substantially matched), the system can go into a destructive resonant vibration.

By rectifying each generator output and connecting them in series, these potential problems are avoided or minimized. In this example, each generator 31, 32 is isolated electrically from the other. The phase angle between the corresponding sinusoidal outputs of the three phases on each generator is preferably still kept as close to zero as possible or as needed. That is, the relative angular positions of the stator assemblies are preferably carefully adjusted to bring the sinusoidal outputs of each generator exactly (or substantially) in phase with each other. This has the effect of making the loads absorbed by each generator exactly (or substantially) equal at a given instant in time. This advantageously keeps the side loads on the displacer rod bearing 11, the guide 17 and pistons 9, 10 as close to or equal to zero as possible. It is still advantageous, although not required, that the generators are otherwise as similar as possible. For example, it is desirable that the generators have the same number of turns, winding resistance, and/or magnet field strength, etc.

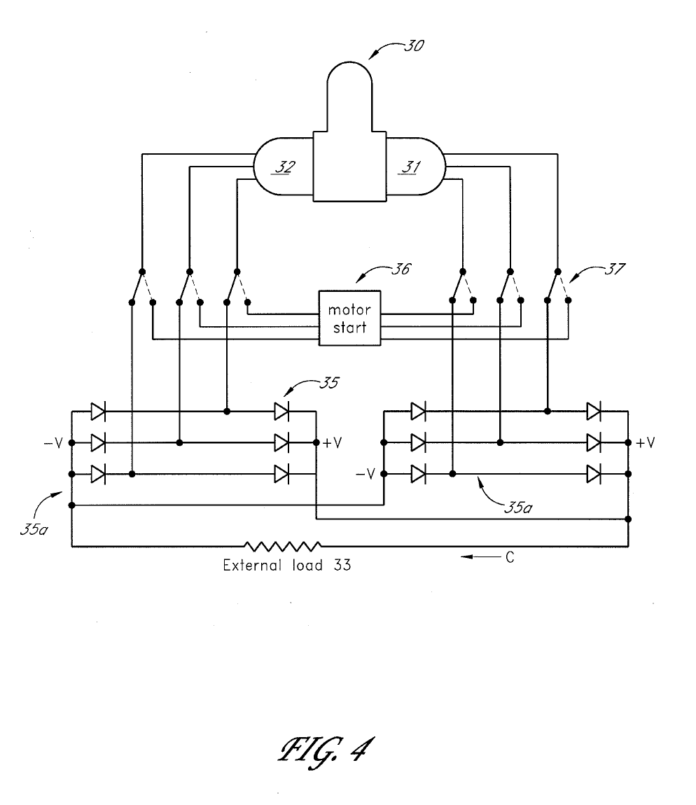

In light of the disclosure herein, those of skill in the art will recognize various other embodiments for electrically connecting the motors given the goal of providing a substantially equal load to the crankshafts 5, 21. For example, FIG. 4 illustrates a modified embodiment of electrically arranging the motors 31, 32. In this embodiment, the generators 31, 32 are arranged in parallel to the external load 33 after being rectified.

In the embodiments described above, there are at least three general ways to deal with the high average gas pressures in the Stirling engine: (i) use rod seals on both piston rods to isolate the working gas from the crankcase, permitting the crankcase to be at atmospheric pressure; (ii) pressurize the crankcase as well, and use a shaft seal where the output shaft(s) extend through the crankcase to the driven load; and (iii) hermetically seal the entire mechanism, including the driven load. In the illustrated embodiments which utilize a pair of electric generators, it is generally desirable, although not required, to use methods (i) and (iii) to substantially reduce, minimize or eliminate different levels of torque that might be exerted on the separate shaft seals in the crankcase.

The above described embodiments are particularly advantageous in applications for engines of low power (e.g., 10 kW or less). Such engines might be served better with a single cylinder engine such as those illustrated herein. For example, the “hot end” components of a Stirling engine of any design are costly due to the use of expensive, difficult to work high temperature alloys. In a Stirling Engine that utilizes a four-cylinder swashplate drive, there are four cylinders instead of one, and thus a complex heater, due to the manifolds to and from four cylinders and regenerators. There are also four pressure bearing dynamic piston seals, which are a major source of friction losses. In contrast, a single cylinder rhombic engine has only one such piston seal or seal system (and a much smaller one on the displacer rod). The swashplate engine can also incorporate a unique method of changing power, by changing the swashplate angle. This results in an elaborate, expensive, and failure-prone system for changing engine pressure. However, the small, single cylinder engine using the modified rhombic drive as described above can be run at a constant power level for charging batteries, for example.

The above-described embodiments can also be applied to a Stirling cooler. In such an embodiment, the engine 200 can be run such that motor-generators 31, 32 are used to move the shafts 9,10 to create a temperature difference. In such an embodiment, the engine 200 acts as a heat pump, forcibly extracting heat from the heater 16 and rejecting it at the cooler 14.

With reference back to FIG. 2C, in the illustrated embodiment, the position of the linear guide 17 with respect to the rods 7, 8 operatively coupled to the power piston 9 and a displacer piston 10 can be adjusted. For example, it certain embodiments it can be advantageous to adjust the lateral position and/or angular orientation of the linear guide 17 with respect to the rods 7,8. To facilitate such movement, the linear guide 17 can be provided with or coupled to an adjustable mount 217. In one embodiment, the mount 217 is configured to allow the lateral position and/or angular orientation of the linear guide 17 to be adjusted with respect to the mount 217. In another embodiment, the lateral position and/or angular orientation of the mount 217 with respect to the crankcase 19 or other support surface can be adjusted. An advantage of either arrangement is that the rods 7,8 and other components of the engine 200 can be assembled together. During such assembly, the rods 7,8 can be slightly off-center and/or have an angular orientation. The linear constraint 17 can then be coupled to one of the rods 7,8 as described above. Misalignment in the system can be compensated by adjusting the lateral position and/or angular orientation of the linear guide 17 before, during or after operation of the engine.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combine with or substituted for one another in order to form varying modes of the disclosed invention.

What is claimed is:

1. A drive mechanism for a Stirling engine, comprising:
a piston rod having a first end and a second end, the first end configured to be coupled to a power piston of the Stirling engine;
a displacer rod having a first end and a second end, the first end being configured to be coupled to a displacer piston of the Stirling engine;
a first crankshaft;
a second crankshaft;
a rhombic drive mechanism comprising a plurality of pivotally connected connection members, the rhombic drive mechanism configured to convert the linear movement of the piston rod to rotational movement of the first and second crankshaft and to convert linear movement of the piston rod to movement of the displacer rod; and
a linear constraint configured to substantially prevent lateral motion while allowing axial movement of at least one of said displacer rod and said piston rod.

2. The drive mechanism of claim 1, wherein the linear constraint is configured to constrain lateral motion of the piston rod.

3. The drive mechanism of claim 1, wherein the linear constraint is configured to constrain lateral motion of the displacer rod.

4. The drive mechanism of claim 3, wherein the linear constraint is positioned at the second end of the displacer rod.

5. The drive mechanism of claim 3, wherein the displacer rod extends through the power piston and the linear constraint comprise an extension on the power piston.

6. The drive mechanism as in claim 1, wherein the linear constraint is a bearing, a linear ball bushing, or a flexure.

7. The drive mechanism of claim 1, wherein the displacer rod extends through the piston rod.

8. The drive mechanism of claim 1, wherein the rhombic drive mechanism comprises a first yoke coupled to the second end of the piston rod and a second yoke coupled to the second end of the displacer rod.

9. The drive mechanism of claim 1, wherein the piston rod and the displacer rod move in a first direction that is at a right angle to the rotational axis of the first and second crankshaft, which are parallel to each other.

10. The drive mechanism of claim 9, wherein the first and second crankshafts lie in a common plane and are equidistant from the displacer and piston rods.

11. The drive mechanism of claim 9, wherein the rhombic drive mechanism comprises a crankpin associated with each crankshaft and the axis of each crank pin is parallel to rotational axis of its respective crankshaft.

12. The drive mechanism of claim 9, further comprising means for applying a substantially equal torque to the first and second crankshafts.

13. The drive mechanism of claim 9, wherein the rhombic drive mechanism is gearless.

14. The drive mechanism of claim 9, wherein the torque loads on the first and second crankshafts are substantially equal.

15. A Stirling cycle engine, comprising:
a cylinder;
a displacer piston configured for reciprocal movement along a first axis within the cylinder;
a power piston configured for reciprocal movement along the first axis in the cylinder;
a piston rod having a first end and a second end, the first end coupled to the power piston;
a displacer rod having a first end and a second end, the first end coupled to the displacer piston, the displacer rod extending through the power piston and the piston rod;
a first crankshaft having a rotational axis that is substantially perpendicular to the first axis;
a second crankshaft having a rotational axis that is substantially perpendicular to the first axis and substantially parallel to the rotational axis of the first crankshaft;
a first yoke coupled to the second end of the piston rod;
a second yoke coupled to the second end of the displacer rod;
a first pair of connection member that are each pivotally coupled to a crank pin for the first crankshaft and one of the first or second yokes;
a second pair of connections that are each pivotally coupled to a crank pin for the second crankshaft and one of the first or second yokes; and
a linear constraint positioned about at least one of the displacer rod or the piston rod.

16. A Stirling cycle engine as in claim 15, further comprising a first motor-generator and a second, substantially identical motor-generator and wherein the first motor-generator is coupled to the first crankshaft and the second motor-generator is coupled to the second crankshaft.

17. A Stirling cycle engine as in claim 16, wherein the engine and the first and second motor-generators are sealed within a common pressure tight housing.

18. A Stirling cycle engine as in claim 16, wherein the first and second motor-generators are three phase brushless motors.

19. A Stirling cycle engine as in claim 16, wherein the first and second motor-generators contain stators and wherein the respective stators of the first and second motor-generators are aligned with each other so that the waveforms of the generated voltage from the first and second motor-generator are in phase with each other.

20. A Stirling cycle engine as in claim 16, comprising an electrical circuit configured such that, in a generating mode, an output of each motor-generator is first rectified and then combined in series with the other motor-generator to feed a load on the engine.

21. A Stirling cycle engine, comprising:
a cylinder;
a displacer piston configured for reciprocal movement along a first axis within the cylinder;
a power piston configured for reciprocal movement along the first axis in the cylinder;
a piston rod having a first end and a second end, the first end coupled to the power piston;
a displacer rod that extends at least partially through the power piston and the piston rod, the displacer rod having a first end and a second end, the first end coupled to the displacer piston;
a first crankshaft having a rotational axis that is substantially perpendicular to the first axis;
a second crankshaft having a rotational axis that is substantially perpendicular to the first axis and substantially parallel to the rotational axis of the first crankshaft;
a rhombic drive mechanism comprising a plurality of pivotally connected connection members, the rhombic drive mechanism configured to convert the linear movement of the piston rod to the rotational movement of the first and second crankshaft and to convert linear movement of the piston rod to movement of the displacer rod; and
means for constraining, without timing gears, straight-line motion of the displacer rod and the piston rod.

22. The Stirling cycle engine of claim 21, further comprising means for exerting substantially equal torque on the first and second crankshafts.

23. The Stirling cycle engine of claim 21, wherein a position and orientation of the means for constraining straight-line motion of the displacer rod and the piston rod is adjustable.

24. A drive mechanism adapted to operatively couple to an engine, the engine comprising a power piston and a displacer piston, the drive mechanism comprising:
a plurality of rods comprising a first rod coupled to the power piston and a second rod coupled to the displacer piston;
a plurality of crankshafts comprising a first crankshaft and a second crankshaft;
a first plurality of linkages, pivotally coupling the first rod to the first crankshaft and to the second crankshaft, for converting axial displacement of the first rod to rotational displacement of the plurality of crankshafts;
a second plurality of linkages, pivotally coupling the second rod to the first crankshaft and to the second crankshaft, for converting rotational displacement of the plurality of crankshafts to axial displacement of the second rod; and
a guide adapted to constrain displacement of at least one of the plurality of rods to axial displacement.

25. The drive mechanism of claim 24, wherein the guide is a linear guide.

26. The drive mechanism of claim 24, wherein the guide is configured to inhibit non-axial displacement of the piston rod.

27. The drive mechanism of claim 24, wherein the guide is configured to inhibit non-axial displacement of the displacer rod.

28. The drive mechanism as in claim 24, wherein the guide is selected from the group consisting of: one or more bearings, one or more linear ball bushings, one or more flexures, or one or more skirts, and a combination thereof.

29. The drive mechanism as in claim 24, wherein the drive mechanism is a rhombic drive mechanism.

30. The drive mechanism as in claim 24, wherein the engine is a Stirling engine.

31. The drive mechanism as in claim 24, wherein the drive mechanism further comprises a first generator coupled to the first crankshaft and a second generator coupled to the second crankshaft.

32. The drive mechanism as in claim 24, wherein the first generator and second generator are adapted to be electrically coupled in series.

33. The drive mechanism as in claim 24, wherein the first generator and second generator are adapted to be electrically coupled in parallel.

34. The drive mechanism as in claim 24, wherein the engine is a Stirling cooler.

35. The drive mechanism as in claim 24, further comprising a mount coupled to the guide, the mount configured to adjust at least one of a lateral and an angular orientation of the guide with respect to the first rod and the second rod.
